(19) United States
(12) Patent Application Publication
(10) Pub. No.: US 2007/0036261 A1
(43) Pub. Date: Feb. 15, 2007

(54) Plate-type nuclear fuels having regularly arranged coarse spherical particles of U-Mo- or U-Mo-X alloy and fabrication method thereof

(75) Inventors: Chang Kyu Kim, Daejeon-si (KR); Eun Jung, Ulsan-si (KR); Yoon Sang Lee, Daejeon si (KR); Ho Jin Ryu, Daejeon-si (KR)

Correspondence Address: BACHMAN & LAPOINTE, P.C., 900 CHAPEL STREET, SUITE 1201, NEW HAVEN, CT, 06510, US

(73) Assignees: Korea Atomic Energy Research Institute; Korea Hydro & Nuclear Power Co. Ltd.

(21) Appl. No.: 11/269,104

(22) Filed: Nov. 8, 2005

(30) Foreign Application Priority Data
Jul. 29, 2005 (KR) 10-2005-0069469

(51) Int. Cl. G21C 3/00

(52) U.S. Cl. 376/409

(57) ABSTRACT

A plate-type nuclear fuel having regularly arranged coarse particles of a gamma-phase U—Mo or U—Mo—X alloy and a fabrication method thereof and, more particularly, to a plate-type nuclear fuel having coarse spherical particles of a stable gamma-phase U—Mo or U—Mo—X alloy arranged regularly on an aluminum cladding in at least one layer and a fabrication method thereof. Operation limit power, high temperature irradiation stability and performance are advantageously improved by preventing excessive reaction between a nuclear fuel and aluminum matrix through minimization of the area of interaction layers between the fuel and aluminum matrix, minimizing pores and swelling by restraining reaction layer formation of an intermetallic compound, and maintaining high thermal conductivity to transfer internal temperature of the nuclear fuel smoothly.

### BACKGROUND OF THE INVENTION

1. Field of the Invention

The present invention relates to a plate-type nuclear fuel having regularly arranged coarse particles of a gamma-phase U—Mo or U—Mo—X alloy and a fabrication method thereof and, more particularly, is directed to a plate-type nuclear fuel having high temperature irradiation stability and improved performance by arranging regularly coarse spherical particles of a stable gamma-phase U—Mo or U—Mo—X alloy on an aluminum cladding in at least one layer and thereby minimizing the area of interaction layers between fuel particles and a matrix, and a fabrication method thereof.

2. Description of the Prior Art

Radioactive rays and a large amount of heat are dissipated by nuclear fission of uranium. Power reactors use the heat and research reactors use the radioactive rays. A nuclear fuel is a material that is used for the nuclear fission. Research reactors have generally used a high-enriched uranium having above 90% uranium content as a nuclear fuel to get high neutron flux suitable for effective research. However, the high-enriched uranium increases the danger of proliferation of nuclear weapons. To prevent nuclear proliferation, development of low-enriched uranium alloys for nuclear fuel commenced in 1978 under the leadership of the U.S.A. Researchers have tried to solve problems by reducing enrichment levels through development of high density nuclear fuels that can increase uranium loading.

Uranium silicide is a uranium alloy having a very high uranium density and excellent combustion stability, and a metal matrix dispersion nuclear fuel having uranium silicides (U₃Si or U₃Si₂) dispersed in an aluminum matrix has been developed. A dispersion nuclear fuel is a fuel having nuclear fuel particles such as uranium alloy dispersed in a material such as aluminum having high thermal conductivity and capable of maintaining temperature of the fuel at a low level. Since late 1980 high-enriched fuels of UAlₓ have been replaced by low-enriched fuels of uranium silicide. A dispersion nuclear fuel having nuclear fuel particles of uranium silicide dispersed in an aluminum matrix has successfully converted research reactors that require a nuclear fuel loading up to a density of 4.8 gU/cc.

High performance research reactors require a high density nuclear fuel, and research on high density nuclear fuels is carried out continuously. However, a nuclear fuel having sufficiently high density was not fabricated, and researchers have faced a new problem that reprocessing of spent nuclear fuels, which is one of the disposal methods of nuclear fuel after use, is difficult. Accordingly, researchers have started to seek materials that have uranium density higher than that of a uranium silicide nuclear fuel and allow easy reprocessing. Development of uranium-molybdenum nuclear fuels has been carried out intensively since late 1990, because it was found that a uranium-molybdenum nuclear fuel made of uranium-molybdenum (U—Mo) alloy may be used as a high density nuclear fuel and shows excellent combustion stability when used as a nuclear fuel in an atomic reactor.

Stepwise irradiation tests were carried out to check the performance of a uranium-molybdenum nuclear fuel. Good results were obtained when irradiation tests were carried out at a low power. However a problem of breakage of the nuclear fuel occurred at a high power. The temperature of the nuclear fuel rises at a high power, the reaction between aluminum and uranium increases rapidly, and pores and UAlx, which is an intermetallic compound, are formed. The pores and low density UAlx increase the volume of the nuclear fuel and cause swelling. The pores and UAlx, which has low thermal conductivity, increase the temperature of the nuclear fuel and thereby cause more swelling. Excessive swelling becomes a direct cause of breakage of the nuclear fuel.

Reaction between aluminum and uranium occurs more frequently as the area of interaction layers between nuclear fuel particles and aluminum increases. The thickness of the formed UAlx is almost constant regardless of particle sizes of the nuclear fuel and the volume of UAlx increases as the area of interaction layers increases. The area of interaction layers should be reduced because increase of UAlx becomes a cause of increased temperature and swelling.

Nuclear fuels for research reactors are classified into a plate-type and a rod-type. Irradiation testing of a plate-type monolithic uranium-molybdenum nuclear fuel was carried out by Argonne National Laboratory and good results were obtained.

However, severe reaction with an aluminum matrix occurs in a dispersion nuclear fuel using particles of an existing uranium-molybdenum alloy fuel with a size less than 100 μm when burned in an atomic reactor at a high power condition, and swelling increases rapidly at a temperature above 550° C. The area of interaction layers may be greatly reduced in a monolithic nuclear fuel. Although the monolithic nuclear fuel may reduce the area of interaction layers substantially, it has a disadvantage that it should be machined as a very thin plate.

FIG. 1 is a photograph of a uranium-molybdenum alloy after irradiation testing of a dispersion nuclear fuel according to the prior art. It shows that the dispersion nuclear fuel has nuclear fuel particles of uranium alloy dispersed in an aluminum matrix, and that reaction layers are formed at the surfaces of the nuclear fuel particles. It is identified that the thickness of the reaction layers is almost constant regardless of the sizes of the nuclear fuel particles. The above reaction increases as temperature rises. Severe reaction occurs at a temperature above 525° C., excessive intermetallic compounds are formed and thereby become a cause of cracks occurring due to volume expansion. Temperature in the central part of the nuclear fuel particles rises gradually as combustion proceeds due to reduction in heat transfer between nuclear fuel particles and an aluminum matrix because the intermetallic reaction layers have low thermal conductivity. The reaction layers, which have low density, cause volume expansion of nuclear fuel core materials and have a great influence on stability and performance of the nuclear fuel by breaking a cladding material.

Fabrication of a nuclear fuel that may reduce the area of interaction layers between the nuclear fuel particles and matrix, where the reaction layers are formed, is required.

To solve the above problems, inventors have carried out research intensively. As a result, a plate-type nuclear fuel was fabricated by manufacturing coarse spherical particles of a stable gamma phase uranium-molybdenum alloy and subsequently arranging regularly the coarse spherical particles on an aluminum cladding in at least one layer. Inventors have found that a nuclear fuel may prevent excessive reaction between nuclear fuel particles and aluminum matrix by minimizing the area of interaction layers between the nuclear fuel particles and aluminum matrix, may minimize pores and swelling by restraining formation of reaction layers of intermetallic compounds and may maintain high thermal conductivity to transfer internal temperature of the nuclear fuel smoothly, and thereby completed the invention.

### SUMMARY OF THE INVENTION

An object of the present invention is to provide a plate-type nuclear fuel by regularly arranging coarse spherical particles of a stable gamma-phase U—Mo or U—Mo—X alloy on an aluminum cladding in at least one layer and a fabrication method thereof to prevent excessive reaction between nuclear fuel particles and an aluminum matrix by minimizing the area of interaction layers between the nuclear fuel particles and the aluminum matrix, to minimize pores and swelling by restraining formation of reaction layers of intermetallic compounds, and to maintain high thermal conductivity to transfer internal temperature of the nuclear fuel smoothly.

The present invention provides a fabrication method of a plate-type nuclear fuel comprising the steps of; manufacturing coarse spherical particles of a stable gamma phase nuclear fuel with U—Mo or U—Mo—X alloy, arranging regularly the spherical particles on an aluminum cladding in at least one layer, applying aluminum matrix powder on the resulting product, and rolling.

### BRIEF DESCRIPTION OF THE DRAWINGS

FIG. 1 is a photograph of a uranium and molybdenum alloy after irradiation testing of a dispersion nuclear fuel according to the prior art.

FIGS. 2a, 2b and 2c are schematic views of a plate-type nuclear fuel having coarse particles of uranium-molybdenum alloy arranged regularly in a single layer according to an embodiment of the present invention, wherein 2a is a plan view, 2b is a side view and 2c is a perspective view.

FIGS. 3a and 3b are schematic plan and side views of a plate-type nuclear fuel having coarse particles of uranium-molybdenum alloy arranged regularly in two layers according to another embodiment of the present invention.

FIGS. 4a and 4b are graphs showing a temperature distribution calculated by ANSYS in an atomic reactor using a plate-type nuclear fuel having coarse particles arranged regularly according to an embodiment of the present invention.

FIGS. 5a and 5b are micrographs using scanning electron microscopy showing spherical powders of a uranium and molybdenum alloy adjusted to have the size of 300 μm˜700 μm by centrifugal atomization.

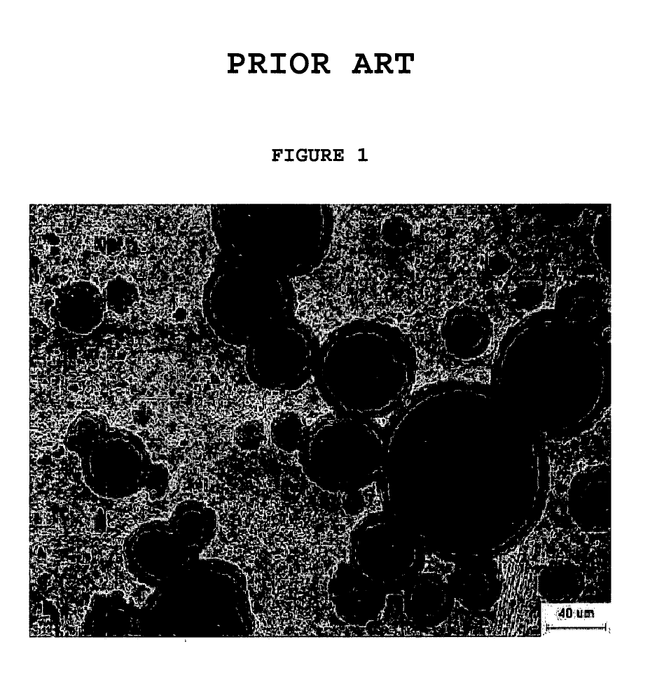

### DETAILED DESCRIPTION OF THE PREFERRED EMBODIMENTS

Hereinafter, example embodiments of the present invention will be described in more detail with reference to the accompanying drawings.

The present invention includes a plate-type nuclear fuel having coarse spherical particles of a stable gamma-phase U—Mo or U—Mo—X alloy arranged regularly on an aluminum cladding in at least one layer.

Aluminum powders may be laminated on the aluminum cladding and fill the gap between the coarse spherical particles. The aluminum surrounds the coarse spherical particles and acts as a heat carrier to transfer heat smoothly. Heat generated from the coarse spherical particles is transferred to the heat carrier having high thermal conductivity, and is dissipated easily to the outside of the plate-type nuclear fuel, thereby reducing the surface temperature of the coarse spherical particles.

If the surface temperature of the spherical particles rises, reaction layers of an intermetallic compound are formed between the U—Mo or U—Mo—X alloy and the aluminum and reduce thermal conductivity between the nuclear fuel particles and the aluminum matrix. This is a cause of rising temperature in the central part of the nuclear fuel. It is known that U—Mo alloy has generally high irradiation stability at a temperature below 600° C. The reaction layers, which have low density, damage the cladding by swelling the volume of the nuclear fuel, and greatly influence the stability and performance of the nuclear fuel.

Therefore, the present invention introduces coarse spherical particles having a predetermined size into an aluminum matrix to minimize the formation of reaction layers of the intermetallic compound by reducing the area of interaction layers and to fabricate a more stable nuclear fuel by lowering the maximum temperature of the interaction layer.

Accordingly, the diameter of the coarse spherical particles of a stable gamma phase U—Mo or U—Mo—X alloy introduced to a plate-type nuclear fuel according to the present invention may preferably be adjusted in the range of 300˜700 μm.

In the case that the diameter of the coarse particles is smaller than 300 μm, reaction between the nuclear fuel particles and matrix occurs severely and swelling occurs rapidly, as with a conventional dispersion nuclear fuel. In the case that the diameter of the coarse particles is greater than 700 μm, they are difficult to apply to a plate-type nuclear fuel having a thickness of 700 μm, highest temperature of the particles is too high, and they are not suitable for a nuclear fuel.

A fabrication method of a plate-type nuclear fuel having the coarse spherical particles arranged regularly according to the present invention comprises the steps of; manufacturing coarse spherical particles of a stable gamma phase nuclear fuel with U—Mo or U—Mo—X alloy, arranging regularly the spherical particles on an aluminum cladding in at least one layer, applying aluminum matrix powder on the resulting product, and rolling.

Firstly, coarse spherical particles of a stable gamma phase nuclear fuel are manufactured with U—Mo or U—Mo—X alloy.

An ingot of uranium alloy of nuclear fuel such as U—Mo alloy is cast. The fabrication method of the coarse spherical particles is not limited. Coarse spherical particles of a nuclear fuel having a diameter of 300˜700 μm may preferably be fabricated by centrifugal atomization or ultrasonic atomization used for the manufacture of uniform solder balls.

Centrifugal atomization is a technique that forms metal particles by pouring a molten metal on a disc rotating at high speed, forming droplets of the molten metal by centrifugal force and coagulating them to a spherical form by cooling during falling.

Ultrasonic atomization is a technique that forms metal particles by applying pressure to a molten metal in a furnace having orifices on its underside with vibration under an inert gas atmosphere, forming droplets from the orifices and forming metal particles by cooling of the droplets during falling in the direction flow counter to the cooling gas. The size of the droplets is influenced by the size of the orifice, gas pressure and ultrasonic vibration. If the above condition is fixed, the size of the droplets is almost constant and particle sizes of a U—Mo—X product are almost constant. An ultrasonic vibration generator uses a PZT or a solenoid vibrator, and its components comprise a function generator generating a predetermined frequency and sine wave, an oscilloscope observing the frequency and sine wave, an amplifier amplifying the sine wave, and a transformer. An example of fabrication conditions of spherical particle powders of U—Mo—X alloy is shown in Table 1.

TABLE 1
Fabrication conditions of spherical particles of U—Mo—X
alloy by ultrasonic atomization method

| particle | 700 | μm | 500 | μm | 300 | μm |
|---|---|---|---|---|---|---|
| diameter | | | | | | |
| condition | | | | | | |
| orifice | about | | about | | about | |
| diameter | 350 | μm | 350 | μm | 350 | μm |
| vibration | about | | about | | about | |
| frequency | 1000 | Hz | 2000 | Hz | 3500 | Hz |
| gas | Ar | | Ar | | Ar | |
| pressure | 30 | kPa | 45 | kPa | 70 | kPa |
| overheating | 150° | C. | 150° | C. | 150° | C. |
| degree | | | | | | |
| vacuum | 10⁻³ | torr | 10⁻³ | torr | 10⁻³ | torr |
| degree | | | | | | |

The coarse spherical particles are arranged regularly in at least one layer, preferably one or two layers, on an aluminum cladding where aluminum powders may be laminated additionally, and subsequently rolling is performed after applying aluminum powders.

An arranging method is not limited in this invention. Preferable examples of an arranging method are described as follows.

In a first method, grooves of a lattice shape are machined or cast in a surface of an aluminum cladding that contacts nuclear fuel particle layers. Coarse spherical particles of the nuclear fuel are arranged along the grooves, aluminum powders are then applied to the regions between the grooves, and rolling is performed. Filling density may be controlled by adjusting the distance between the grooves.

In a second method, aluminum powders are laminated on an aluminum cladding, coarse spherical particles of a nuclear fuel arranged uniformly are placed on a wire mesh, the wire mesh is taken out, and rolling is performed. If a wire mesh made of aluminum is used, rolling may be performed without removing the wire mesh.

In a third method, an aluminum cladding is machined in a rectangular box. Spherical powders are loaded in the box, arranged uniformly by vibration, aluminum powders are applied to the gaps between particles, and rolling is performed. This method utilizes a tendency of close packing of spherical particles and may be used to achieve maximum filling density.

In a fourth method, aluminum powders are compacted by a die for producing spherical protrusions whose diameters are the same as those of the coarse spherical particles of the nuclear fuel, the coarse spherical particles of the nuclear fuel are loaded on the powder compact and covered by aluminum powders, and rolling is performed.

Various changes and modifications may be made to the above arranging methods by those skilled in the art. Although the invention will be described in detail with reference to exemplary embodiments, it should be understood that the invention is not limited to the embodiments herein disclosed.

### EXAMPLE 1

### Fabrication of a Plate-Type Nuclear Fuel According to the Present Invention

A uranium-molybdenum mother alloy ingot is prepared by vacuum induction heating fusion casting to manufacture a specimen for nuclear fuel irradiation. A U—Mo—X mother alloy ingot is loaded in a furnace having holes of 250 μm in its underside, heated under an argon atmosphere, its temperature is measured when a molten metal is formed, and heated additionally to a temperature more than 150° C. above the measured temperature. Inert argon gas for cooling is supplied to flow from the bottom to the top of the path through which molten metal droplets pass, beneath the lower side of the furnace, a vibration generator preset at 2000 Hz is activated, and a pressure of 45 kPa is applied to the furnace by the inert argon gas. Coarse spherical particles of the nuclear fuel having a diameter of 500 μm are prepared through the above procedure. Mo homogenization is performed for 6 hours at 1000° C. and the resulting product is quenched to form a gamma phase structure. The coarse spherical particles of the nuclear fuel are arranged regularly in a single layer on an aluminum cladding formed with grooves in a lattice shape, aluminum powders are applied to the regions of the grooves, and rolling is performed. A plate-type nuclear fuel according to the present invention is thus completed.

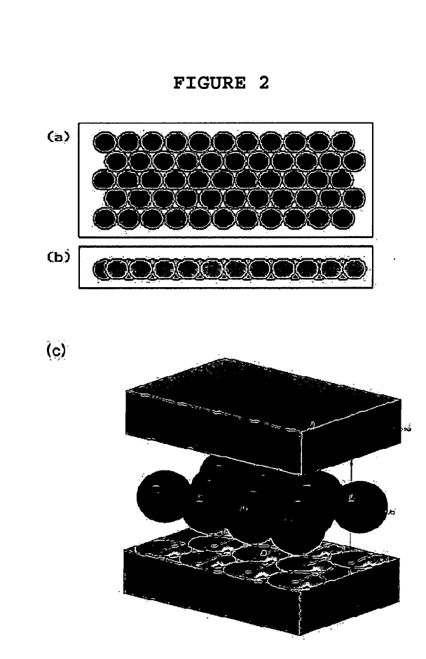

FIGS. 2a, 2b and 2c are schematic views of a plate-type nuclear fuel having coarse particles of uranium-molybdenum alloy arranged regularly in a single layer according to Example 1 of the present invention, wherein 2a is a plan view, 2b is a side view and 2c is a perspective view.

### EXAMPLE 2

### Fabrication of a Plate-Type Nuclear Fuel According to the Present Invention

A plate-type nuclear fuel according to the present invention is fabricated by the same method as in Example 1 except that coarse spherical particles of the nuclear fuel are regularly arranged in two layers.

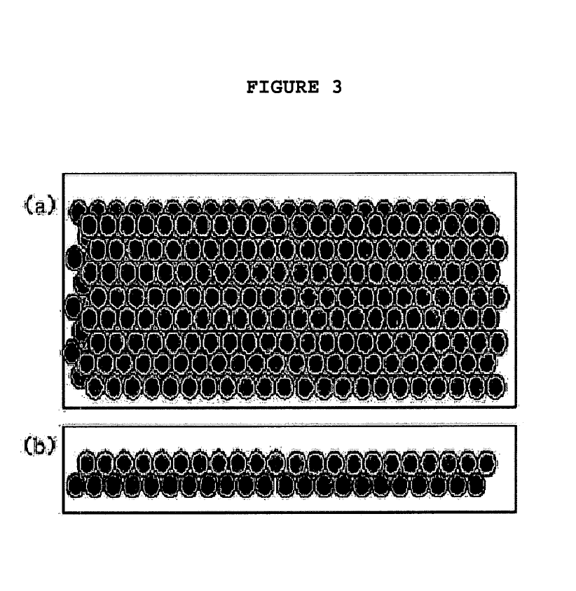

FIGS. 3a and 3b are schematic views of a plate-type nuclear fuel having coarse particles of uranium-molybdenum alloy arranged regularly in two layers according to Example 2 of the present invention, wherein 3a is a front view and 3b is a side view.

### COMPARATIVE EXAMPLE 1

### Dispersion Nuclear Fuel

A plate-type dispersion nuclear fuel mixed uniformly with a U—Mo alloy nuclear fuel and aluminum is prepared.

### EXPERIMENTAL EXAMPLE 1

### Temperature Distribution Calculation and Performance Prediction Test of a Plate-Type Nuclear Fuel According to the Present Invention

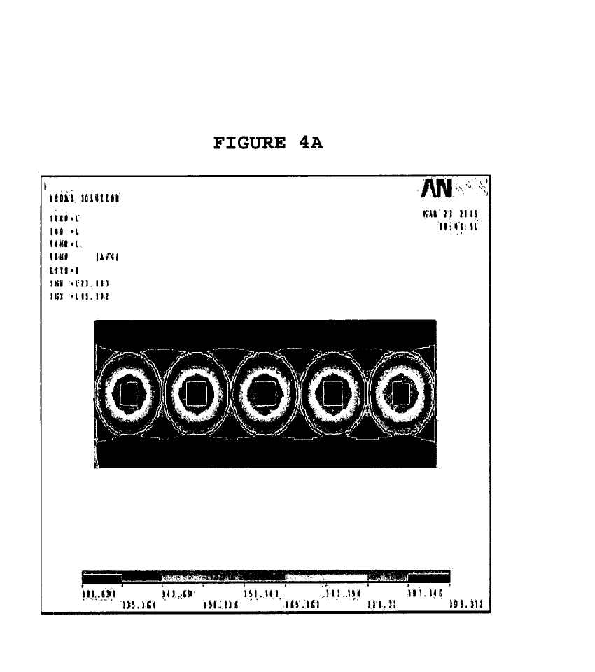

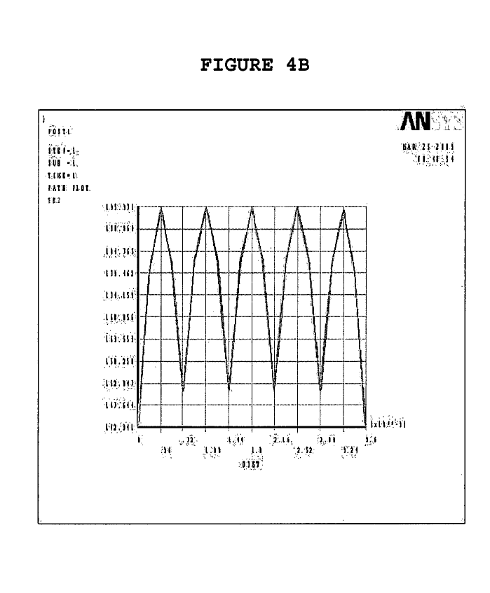

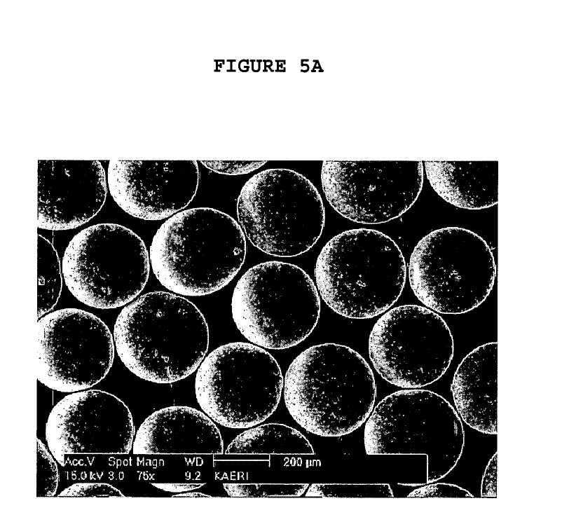

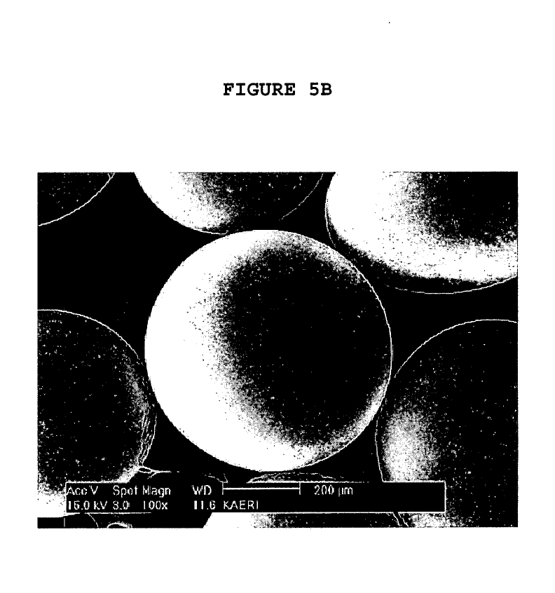

Temperature distribution of a plate-type nuclear fuel according to the present invention is calculated by ANSYS code. As shown in FIG. 4, a temperature calculation model for an atomic reactor with a plate-type nuclear fuel having regularly arranged coarse particles according to Example 1 is established. In the case that the coarse spherical particles according to the present invention are used, heat power density is calculated as 2.65×1010 W/cm³ in an arrangement of coarse particles, compared to the standard of heat flux of the Jules Horowitz Reactor, a high power atomic reactor in France, which is 560 W/cm². Temperature difference (ΔT) between the center and outer interaction layers of the nuclear fuel particle (15 W/mK) is 36° C. when calculated by the following heat transfer formula.

$$4 π {r}^{2} \frac{ⅆ t}{ⅆ r} = \frac{q}{k} 4 \frac{π}{3} {r}^{3}$$

Volume fraction of the nuclear fuel is calculated as 0.605 and temperature difference occurring in an aluminum cladding (230 W/mK) of 0.25 mm thickness is calculated as 9.4° C. Accordingly, this shows that temperature increase is not large when coarse particles are used.

On the other hand, the maximum temperature of the interaction layers in the center of the dispersion nuclear fuel according to Comparative Example 1 is 214° C.

As shown in FIG. 4, the maximum temperature of a plate-type nuclear fuel having the coarse spherical particles arranged regularly in a single layer according to an embodiment of the present invention is 195.372° C. and the temperature in interaction layers of the nuclear fuel is 142.69° C.

As described above, the maximum temperature of the interaction layers of the nuclear fuel particle is lower than 214° C., the maximum temperature of the interaction layer of the dispersion nuclear fuel according to Comparative Example 1, hence the reaction between aluminum matrix and U—Mo nuclear fuel may be reduced and the maximum temperature of the nuclear fuel is 195.372° C. Therefore a plate-type nuclear fuel having coarse spherical particles regularly arranged in a single layer according to an embodiment of the present invention is suitable as a nuclear fuel.

A plate-type nuclear fuel having coarse spherical particles of a stable gamma-phase U—Mo or U—Mo—X alloy regularly arranged on an aluminum cladding in at least one layer and a fabrication method thereof provides a structure that minimizes the area of interaction layers between a nuclear fuel and an aluminum matrix. When compared with existing dispersion nuclear fuels of U alloy, operation limit power, high temperature irradiation stability and performance are improved by preventing excessive reaction between the nuclear fuel and aluminum matrix, minimizing pores and swelling by restraining formation of reaction layers of an intermetallic compound, and maintaining high thermal conductivity to transfer internal temperature of the nuclear fuel smoothly.

1. A plate-type nuclear fuel having spherical particles of a gamma-phase U—Mo alloy arranged regularly on an aluminum cladding in one layer or two layers, wherein the diameter of the spherical particles of the gamma phase U—Mo alloy is in the range of 300˜700 μm.

2-5. (canceled)
